(19) United States
(12) Patent Application Publication
(10) Pub. No.: US 2012/0322326 A1
(43) Pub. Date: Dec. 20, 2012

(54) COMPOSITE POLYAMIDE ARTICLE

(76) Inventors: Gilles Orange, Vourles (FR); Roland Durand, Saint Bonnet De Mure (FR); Franck Touraud, Eyzin Pinet (FR)

(21) Appl. No.: 13/383,195

(22) PCT Filed: Jun. 30, 2010
(86) PCT No.: PCT/EP2010/059276

§ 371 Date: Sep. 4, 2012

(30) Foreign Application Priority Data
Jul. 9, 2009 (FR) 0954768

(51) Int. Cl. B05D 3/00; B32B 27/12

(52) U.S. Cl. 442/59; 427/389.9; 427/389.8; 427/392

(57) ABSTRACT

The use of polyamide of high melt flow employed in the impregnation of reinforcing materials taking the form of a cloth of industrial fabrics for the manufacture of composite materials is described. The described use relates to composite materials and their manufacturing processes.

The present invention relates to the use of polyamide of high melt flow employed in the impregnation of reinforcing materials taking the form of cloth of industrial fabrics for the manufacture of composite materials. The field of the invention is that of composite materials and of their manufacturing processes.

### PRIOR ART

In the field of high-performance materials, composites have assumed a dominating position because of their performance and the savings in weight which they allow. The currently most well known high-performance composites are obtained from thermosetting resins, use of which is limited to small-scale to moderate-scale applications, mainly in aeronautics or motor sports, and, in the best cases, which exhibit manufacturing times in the region of approximately fifteen minutes, such as, for example, during the manufacture of skis. The cost of these materials and/or the manufacturing times make it difficult to render them compatible with use in mass production. Furthermore, the use of thermosetting resins often involves the presence of solvents and of monomers. Finally, these composites are difficult to recycle.

One response, with regard to the manufacturing times, is given by composites comprising a thermoplastic matrix. Thermoplastic polymers are generally known for their high viscosity, which constitutes a check as regards the impregnation of the reinforcing materials, generally composed of very dense multifilament bundles. The use of the thermoplastic matrices available on the market results in a difficulty in impregnation, requiring either prolonged impregnation times or significant processing pressures. In the majority of cases, the composite materials obtained from these matrices may exhibit microspaces and unimpregnated regions. These microspaces bring about declines in mechanical properties, premature aging of the material and problems of delamination when the material is composed of several reinforcing layers. This phenomenon of loss of mechanical properties is furthermore accentuated when the cycle times for the manufacture of the composite articles decrease.

Another problem frequently encountered with composite materials comprising a polymer matrix is their resistance to aging and more particularly to hygrothermal aging. The diffusion of water within composite materials results in a substantial modification of certain physical characteristics, such as, for example, the glass transition temperature, or a swelling of the matrix. A modification at the matrix/fibers interfaces may also be observed, generally with an irreversible nature. This aging is expressed by a deterioration in the mechanical performance, in particular the ultimate strength. It is then necessary to oversize the components, which results in an increase in weight and a not insignificant additional expenditure.

The object of the present invention is thus to overcome these disadvantages by providing a composite article which can be manufactured with short cycle times while having good use properties, such as good mechanical properties, and good resistance to hygrothermal aging.

### INVENTION

The Applicant Company has discovered, unexpectedly, that the use of novolac resin in polyamides of high melt flow in the manufacture of composite articles makes it possible to obtain articles exhibiting not only good mechanical properties, such as in particular stiffness, ultimate strength, impact strength and fatigue behavior, even when they are manufactured with shorter cycle times than those normally used and without any other treatment, but also good resistance to hygrothermal aging. This makes it possible to provide a composite material exhibiting both an advantage of reduction in manufacturing costs, by the use of equipment employing shortened cycle times, and also sufficient durability for structural applications.

These composite articles exhibit in particular very good maintenance of the mechanical properties after hygrothermal aging, in particular in comparison with conventional polyamide composite articles.

The articles according to the invention exhibit in particular the advantages of stiffness, lightness and ability to be recycled, and a good surface appearance.

These articles also exhibit good flame-retardancy properties.

A first subject matter of the invention is a process for the manufacture of a composite article comprising at least:

a) a stage of impregnation of a reinforcing cloth with a polyamide composition in the molten state, exhibiting a melt viscosity η of between 1 and 50 Pa·s, said polyamide composition comprising from 5 to 50% by weight of novolac resin;
b) a stage of cooling and subsequently of recovering the composite article.

The present invention also relates to a composite article comprising at least one reinforcing cloth and one polyamide matrix comprising from 5 to 50% by weight of novolac resin, said polyamide matrix preferably exhibiting a melt viscosity of between 1 and 50 Pa·s.

Cloth is understood to mean a textile surface of yarns or fibers which are optionally rendered integral by any process, such as, in particular, adhesive bonding, felting, braiding, weaving or knitting. These cloths are also denoted as fibrous or filamentary networks. Yarn is understood to mean a monofilament, a continuous multifilament yarn or a staple fiber yarn obtained from fibers of a single type or from several types of fibers as an intimate mixture. The continuous yarn can also be obtained by assembling several multifilament yarns. Fiber is understood to mean a filament or a combination of filaments which are cut, cracked or converted.

The reinforcing yarns and/or fibers according to the invention are preferably chosen from yarns and/or fibers formed of carbon, glass, aramids, polyimides, flax, hemp, sisal, coir, jute, kenaf and/or their mixture. More preferably, the reinforcing cloths are composed solely of reinforcing yarns and/or fibers chosen from yarns and/or fibers formed of carbon, glass, aramids, polyimides, flax, hemp, sisal, coir, jute, kenaf and/or their mixture.

These cloths preferably have a grammage, that is to say the weight per square meter, of between 100 and 1000 g/m².

Their structure may be random, unidirectional (1D) or multidirectional (2D, 2.5D, 3D or other).

A composite article according to the invention can comprise several reinforcing cloths which are identical or different in nature.

The polyamide according to the invention exhibits a melt viscosity η of between 1 and 50 Pa·s. This viscosity can be measured using a plate/plate rheometer with a diameter of 50 mm under a stepwise shear sweep ranging from 1 to 160 s⁻¹. The polymer is in the form of a film with a thickness of 150 μm, of granules or of powder. The polymer is brought to a temperature of 25 to 30° C. above its melting point and the measurement is then carried out.

The molecular weight (Mn) of the polyamides is preferably greater than 8000, more preferably between 8000 and 20000, having satisfactory mechanical properties and a degree of hold during various shaping processes.

Semicrystalline polyamides are particularly preferred.

The polyamides can be chosen from the group consisting of polyamides obtained by polycondensation of at least one linear aliphatic dicarboxylic acid with an aliphatic, cycloaliphatic or arylaliphatic (MXD) diamine or between at least one aromatic dicarboxylic acid and an aliphatic, cycloaliphatic or aromatic diamine, polyamides obtained by polycondensation of at least one amino acid or lactam with itself, or their blend and (co)polyamides.

The polyamide of the invention is chosen in particular from the group consisting of polyamides obtained by polycondensation of at least one aliphatic dicarboxylic acid with an aliphatic or cyclic diamine, such as PA 6.6, PA 6.10, PA 6.12, PA 12.12, PA 4.6 or MXD 6, or between at least one aromatic dicarboxylic acid and an aliphatic or aromatic diamine, such as polyterephthalamides, polyisophthalamides or polyaramids, or their blend and (co)polyamides. The polyamide of the invention can also be chosen from polyamides obtained by polycondensation of at least one amino acid or lactam with itself, it being possible for the amino acid to be generated by the hydrolytic opening of a lactam ring, such as, for example, PA 6, PA 7, PA 11 or PA 12, or their blend and (co)polyamides.

Polyamides of high melt flow can in particular be obtained by controlling their molecular weight during the synthesis thereof, in particular by the addition, before or during the polymerization of the polyamide monomers, of monomers which modify the length of the chais, such as, in particular, diamines, dicarboxylic acids, monoamines and/or monocarboxylic acids. It is also possible to add multifunctional compounds to the polymerization.

Polyamides according to the invention can also be obtained by blending, in particular melt blending, polyamides with monomers which modify the length of the chains, such as, in particular, diamines, dicarboxylic acids, monoamines and/or monocarboxylic acids.

The composition of the invention can also comprise copolyamides derived in particular from the above polyamides, or the blends of these polyamides or (co)polyamides.

Use may also be made, as polyamide of high melt flow, of a star polyamide comprising star macromolecular chains and, if appropriate, linear macromolecular chains.

The polyamide possessing a star structure is a polymer comprising star macromolecular chains and, optionally, linear macromolecular chains. The polymers comprising such star macromolecular chains are, for example, described in the documents FR 2 743 077, FR 2 779 730, EP 0 682 057 and EP 0 832 149. These compounds are known to exhibit an improved melt flow in comparison with linear polyamides.

The star macromolecular chains comprise a core and at least three polyamide branches. The branches are bonded to the core by a covalent bond, via an amide group or a group of another nature. The core is an organic or organometallic chemical compound, preferably a hydrocarbon compound optionally comprising heteroatoms and to which the branches are connected. The branches are polyamide chains. The polyamide chains constituting the branches are preferably of the type of those obtained by polymerization of lactams or amino acids, for example of polyamide-6 type.

The polyamide possessing a star structure according to the invention optionally comprises, in addition to the star chains, linear polyamide chains. In this case, the ratio by weight of the amount of star chains to the sum of the amounts of star chains and of linear chains is between 0.5 and 1, limits included. It is preferably between 0.6 and 0.9.

According to a preferred embodiment of the invention, the polyamide possessing a star structure, that is to say comprising star macromolecular chains, is obtained by copolymerization of a mixture of monomers comprising at least:

a) monomers of following general formula (I):

R₁A-Z]ₘ (I)

b) monomers of following general formulae (IIa) and (IIb):

X—R₂—Y (IIa)
or

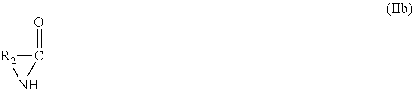

c) optionally monomers of following general formula (III):

Z—R₃—Z (III)

or

R₄—Z (IV)

in which:
R₁ is a linear or cyclic and aromatic or aliphatic hydrocarbon radical comprising at least 2 carbon atoms which can comprise heteroatoms,
A is a covalent bond or an aliphatic hydrocarbon radical which can comprise heteroatoms and which comprises from 1 to 20 carbon atoms,
Z represents a primary amine functional group or a carboxylic acid functional group,
Y is a primary amine functional group when X represents a carboxylic acid functional group or Y is a carboxylic acid functional group when X represents a primary amine functional group,
R₂, R₃ and R₄, which are identical or different, represent substituted or unsubstituted and aliphatic, cycloaliphatic, arylaliphatic or aromatic hydrocarbon radicals comprising from 2 to 20 carbon atoms which can comprise heteroatoms,
m represents an integer between 3 and 8.

Carboxylic acid is understood to mean carboxylic acids and their derivatives, such as acid anhydrides, acid chlorides, amides or esters.

Processes for producing these star polyamides are described in the documents FR 2 743 077 and FR 2 779 730. These processes result in the formation of star macromolecular chains, as a mixture with, optionally, linear macromolecular chains.

If a comonomer of formula (III) is used, the polymerization reaction is advantageously carried out until thermodynamic equilibrium is reached.

The monomer of formula (I) can also be blended with a molten polymer during an extrusion operation.

Thus, according to another embodiment of the invention, the polyamide possessing a star structure is obtained by melt blending, for example using an extrusion device, a polyamide of the type of those obtained by polymerization of lactams and/or amino acids and a monomer of formula (I). Such preparation processes are described in patents EP 0 682 070 and EP 0 672 703.

According to a specific characteristic of the invention, the R₁ radical is either a cycloaliphatic radical, such as the tetravalent cyclohexanonyl radical, or a 1,1,1-propanetriyl or 1,2,3-propanetriyl radical. Mention may be made, as other R₁ radicals suitable for the invention, by way of example, of substituted or unsubstituted trivalent phenyl and cyclohexanyl radicals, tetravalent diaminopolymethylene radicals with a number of methylene groups advantageously of between 2 and 12, such as the radical originating from EDTA (ethylenediaminetetraacetic acid), octavalent cyclohexanonyl or cyclohexadinonyl radicals, and the radicals originating from compounds resulting from the reaction of polyols, such as glycol, pentaerythritol, sorbitol or mannitol, with acrylonitrile.

Advantageously, at least two different R₂ radicals can be employed in the monomers of formula (II).

The A radical is preferably a methylene or polymethylene radical, such as the ethylene, propylene or butylene radicals, or a polyoxyalkylene radical, such as the polyoxyethylene radical.

According to a specific embodiment of the invention, the number m is greater than or equal to 3 and advantageously equal to 3 or 4.

The reactive functional group of the polyfunctional compound represented by the symbol Z is a functional group capable of forming an amide functional group.

Preferably, the compound of formula (I) are chosen from 2,2,6,6-tetra(β-carboxyethyl)cyclohexanone, trimesic acid, 2,4,6-tri(aminocaproic acid)-1,3,5-triazine and 4-aminoethyl-1,8-octanediamine.

The mixture of monomers which is the source of the star macromolecular chains can comprise other compounds, such as chain-limiting agents or catalysts. The following compounds do not necessarily form part of the mixture of monomers which is the source of the star structure but can be added in the synthesis or after additives, such as light stabilizers, heat stabilizers and lubricants.

The composition according to the invention preferably exhibits from 50 to 95% by weight of polyamide, with respect to the total weight of the composition, preferably from 75 to 90% by weight.

Novolac resins are generally condensation products of phenolic compounds with aldehydes or ketones or their derivatives, such as ketal or hemiketal functional groups. These condensation reactions are generally catalyzed by an acid or a base.

The polyamide according to the invention can comprise one or more different types of novolac resin.

Novolac resins generally exhibit a degree of condensation of between 2 and 15.

The phenolic compounds can be chosen, alone or as a mixture, from phenol, cresol, xylenol, naphthol, alkylphenols, such as butylphenol, tert-butylphenol or isooctylphenol, nitrophenol, phenylphenol, resorcinol or bisphenol A; or any other substituted phenol.

The most frequently used aldehyde is formaldehyde. However, others thereof can be used, such as acetaldehyde, paraformaldehyde, butyraldehyde, crotonaldehyde, glyoxal and furfural.

Use may be made, as ketone, of acetone, methyl ethyl ketone or acetophenone.

According to a specific embodiment of the invention, the resin is a condensation product of phenol and formaldehyde.

The novolac resins used advantageously exhibit a molecular weight of between 500 and 3000 g/mol and preferably between 800 and 2000 g/mol.

Mention may in particular be made, as commercial novolac resin, of the commercial products Durez®, Vulkadur® or Rhenosin®.

The polyamide composition comprises from 5 to 50% by weight of novolac resin, more preferably from 10 to 25% by weight, with respect to the total weight of the composition. The percentage by weight is represented with respect to the total weight of the composition.

The polyamide composition according to the invention comprising novolac resin is used in particular as matrix, in particular by granulation, calendering, extrusion in the film form, grinding, injection, molding, injection molding, pressing, and others.

The stage of impregnation of the polyamide composition of the invention and of the reinforcing cloth can be carried out in various ways, according to various possible processes. It is entirely possible to impregnate one or more reinforcing cloths.

It is possible, for example, to inject the molten polyamide composition into a molding chamber comprising at least one or more reinforcing cloths. The interior of the molding chamber is at a temperature of plus or minus 50° C. with respect to the melting point of said polyamide. It is possible subsequently to cool the molding chamber and the article obtained, in order finally to recover said article. This process is also known, under the name of resin transfer molding (RTM) process, as a thermoset process, which consists in injecting resin into a closed mold in which reinforcing fibers have been placed beforehand. This process can be carried out under pressure.

It is also possible to produce a composite article according to the invention by a film stacking process, which consists of a temperature compression of a stack of reinforcing cloths and polyamide films. In particular, one or more reinforcing cloths and one or more films of polyamide of high melt flow are brought into contact and the cloths are impregnated by melting the polyamide. The pressures necessary for good assembling are generally greater than 30 bar.

The composite article according to the invention can also be prepared by bringing one or more reinforcing cloths into contact with powder of a polyamide as defined above, in particular fine powder, and said impregnation is carried out by melting the polyamide at a temperature equal to or greater than that of the melting point of the polyamide, optionally under pressure.

The composite article of the invention can also be produced by pultrusion. This technique generally consists in drawing one or more continuous yarns and fibers through a heated die so as to impregnate it with a molten thermoplastic resin to obtain a finished or semifinished rod or article.

After the impregnation of the reinforcing cloth by the polyamide, the article is obtained by solidifying the matrix. Cooling can advantageously be carried out rapidly, so as to prevent significant crystallization of the polyamide, in particular in order to maintain the properties of the article. Cooling can in particular be carried out in less than 5 minutes, more preferably in less than 1 minute. The mold can, for example, be cooled by a circuit of cold fluid. It is also optionally possible to transfer the composite article into a cold mold, optionally under pressure.

The polyamide composition and/or the composite article according to the invention can also comprise all the additives normally used in polyamide-based compositions used for the manufacture of articles. Thus, mention may be made, as examples of additives, of heat stabilizers, UV stabilizers, antioxidants, lubricants, pigments, dyes, plasticizers, reinforcing fillers and agents which modify the impact strength.

Additives for improving the quality of the reinforcing cloths/polyamide interfaces can also be used. These additives can, for example, be incorporated in the polyamide composition, incorporated in the yarns and/or fibers of the reinforcing cloth, present on the yarns and/or fibers of said cloth or deposited on the reinforcing cloth. These additives can be coupling agents, such as those of aminosilane or chlorosilane type, or liquefying or wetting agents, or their combination.

Reinforcing fillers can be incorporated in the polyamide composition. These fillers can be chosen from fibrous fillers, such as short glass fibers, for example, or nonfibrous fillers, such as kaolin, talc, silica, mica or wollastonite. Their size is generally between 1 and 25 μm. Submicronic, indeed even nanometric, fillers can also be used, alone or supplementing the other fillers.

The present invention relates to an article capable of being obtained by the process of the invention. The article can in particular be a polyamide-based composite article comprising a reinforcing cloth, in which the polyamide exhibits a melt viscosity of between 1 and 50 Pa·s.

The articles according to the invention preferably comprise between 25 and 70% by volume of reinforcing cloth, with respect to the total volume.

The composite articles preferably exhibit, for a degree of reinforcing of 50% by volume, a breaking stress of greater than 480 MPa and an elastic modulus of greater than 20 GPa (for a void content typically of between 0 and 2%).

The articles of the invention can be finished or semi-finished articles which can also be referred to as preimpregnated articles. It is possible, for example, to carry out the thermoforming of the composite articles in the form of sheets in order to give them a defined shape after cooling. The invention thus relates to composite articles or preforms capable of being obtained by the process according to the present invention.

The articles of the invention can also be structures of sandwich type exhibiting a core inserted between two skins. The composites of the invention can be used to form external layers, by combining them with a core of honeycomb type or foam type. The layers can be assembled by chemical or heat bonding.

The composite structures according to the invention can be employed in numerous fields, such as the aeronautical, motor vehicle, energy, electrical or sports and leisure industries. These structures can be used to produce sports equipment, such as skis, or else to produce various surfaces, such as special floors, partitions, vehicle bodies or billboards. In aeronautics, these structures are used in particular for fairings (fuselage, wing, tailplane). In the motor vehicle industry, they are used, for example, for floors or supports, such as parcel shelves, or as structural components.

A specific language is used in the description so as to facilitate understanding of the principle of the invention. Nevertheless, it should be understood that no limitation on the scope of the invention is envisaged by the use of this specific language. Modifications and improvements can in particular be envisaged by a person conversant with the technical field concerned on the basis of his own general knowledge.

The term and/or includes the meanings and, or and all the other possible combinations of the elements connected to this term.

Other details or advantages of the invention will become more clearly apparent in the light of the examples given below purely by way of indication.

### EXPERIMENTAL PART

Different polyamides were used in the examples.
PA C2: high melt flow polyamide 6.6 having a viscosity number VN of 97 and a weight Mw of 11 200.
PA 3: high melt flow polyamide 6.6 having a viscosity number VN of 97, modified by addition of 10% by weight of novolac resin.
PA 4: high melt flow polyamide 6.6 having a viscosity number VN of 97, modified by addition of 20% by weight of novolac resin.

These polyamides were characterized by melt viscosity measurements carried out on an Ares plate/plate rheometer (Rheometrics) at 280° C. for the PA 6.6 polyamides. The curves of viscosity as a function of the shear rate show that the polymers under consideration have a newtonian behavior: the viscosity selected is the value at the plateau (between 1 and 150 s⁻¹).

The reinforcements used in the examples are in the form of preforms made of glass fabrics, cut to the dimensions required for the manufacture of the plaques, that is to say 150×150 mm or 200×300 mm. The reinforcing cloth used is a fabric made of glass fiber) (0°-90° from Synteen & Luckenhaus resulting from a roving of 1200 tex, exhibiting a grammage of 600 g/m².

### Example 1

### Preparation of the Polyamides Modified with Novolac Resin

Polyamide and variable proportions of novolac resin (Rhenosin RB) are melt blended in a twin-screw extruder. The granules are obtained by cutting the rods at the extruder outlet or by underwater pelletizing.

TABLE 1

| | | Characteristics |
|---|---|---|
| | Composition | Viscosity |
| Polymer | Novolac resin | η (Pa · s) |
| PA C2 | 0 | 30 |
| PA 3 | 10% | 20 |
| PA 4 | 20% | 10 |

### Example 2

### Preparation of the Composites

The different polymers under consideration are used in the powder form for the most fluid or otherwise in the film form. The powders are obtained by cryogenic grinding, either in dry ice or in liquid nitrogen. The films are produced by extrusion of granules on a Leistritz twin-screw extruder with a diameter of 34 and an L/D of 34 equipped with a flat die and a film-forming device (extruder flow rate of 10 kg/h, screw speed of 250 rpm, temperature of 270° C. for PA 6.6). The gap between the lips of the die is 300 μm approximately for a width of 30 cm with a delivery rate of 3.2 m/min over rollers regulated at 115° C.: the films obtained have a thickness which varies between 160 and 180 μm (spools with a width of 280 mm).

The polymer films are cut out in the form of sheets with dimensions of 150×150 mm or 200×300 mm from the spools obtained above. It is the same for the reinforcing cloths.

The composite components are prepared by means of a Schwabenthan hydraulic press comprising two temperature-controlled plates (Polystat 300A): heating plates (heating resistances) and cooled plates (circulation of water). A metal mold having a cavity with dimensions of 150 mm×150 mm or 200×300 mm is used.

In order to produce a composite comprising 80% by weight (65% by volume) of glass fibers with the fabric with a grammage of 600 g/m², a metal frame is introduced into the mold and a preform is placed in said metal frame, said preform being composed of an alternating stack comprising 6 sheets of glass fabrics and, between each, either a sheet of polymer or uniformly distributed powder, the two outer layers being sheets of glass fabrics.

The temperature of the plates of the press is raised beforehand either to 250° C. for the PA 6s or to 290° C. for the PA 6.6s, before the introduction of the preform. At this temperature, the pressure is applied between 1 and 50 bar and maintained at this value; ventings are rapidly carried out. The assembly is maintained at the same temperature and pressure, without venting. A series of ventings is again subsequently carried out and then the assembly is again maintained, still at the same temperature and pressure. The mold is then transferred onto the device comprising cooled plates and maintained at a pressure of between 1 and 50 bar.

The composite components thus obtained have a size of 150×150 mm or 200×300 mm and a thickness of approximately 2 mm.

### Example 3

### Characterization of the Composites Based on Modified PA 6.6

A cycle of 5 min under a medium pressure of 15 to 50 bar was carried out: 1 min under 15 bar, then 1 min under 50 bar and then 2 min under 50 bar. This time correspond to the total duration of the cycle between heating up the mold and cooling under pressure (1 min).

The 150×150 mm or 200×300 mm sheets are cut up in order to obtain samples with dimensions of 150×20×2 mm.

A first series of samples is characterized immediately after manufacture (samples placed under a sealed covering, in order to keep them in a dry state RH0).

A conditioning treatment can also be carried out according to the standard ISO 1110, “Plastics-Polyamides-Accelerated conditioning of test specimens”: “RH50” state. The water content at equilibrium is obtained by conditioning the composite components with a cycle of 10 days at 70° C. under a residual humidity RH of 62%.

The mechanical properties were obtained at 23° C. and ambient humidity RH=50%.

The three-point bending tests at ambient temperature are carried out on parallelepipedal test specimens (150×20×2 mm), according to the standard ISO No. 14125, on a Zwick 1478 machine: distance between rods of 64 mm, crosshead velocity of 5 mm/min. The values for Young's elastic modulus E (GPa) and for max stress σ at peak (MPa) are measured and calculated.

Direct tension tests at ambient temperature are carried out on parallelepipedal test specimens (250×25×2 mm), according to the standard ASTM D3039/D3039M, on a Zwick 1478 machine: crosshead velocity of from 1 to 5 mm/min. The values for Young's elastic modulus E (GPa) and for max stress σ at peak (MPa) are measured and calculated.

TABLE 2
Results for the components manufactured according
to Medium pressure cycle (RH0/RH50)

| | |
|---|---|
| Three-point bending | Tension |

| | Elastic | Max | Elastic | Max |
|---|---|---|---|---|
| Polyamide | modulus E | stress σ | modulus E | stress σ |
| used | (GPa) | (MPa) | (GPa) | (MPa) |
| PA C2 RH50 | 27 | 610 | 27 | 498 |
| PA C2 RH0 | 29.1 | 650 | 29 | 520 |
| PA 3 RH50 | 28 | 650 | — | — |
| PA 4 RH0 | 29.4 | 660 | 29.5 | 530 |

In the case of a manufacturing cycle of 5 minutes under medium pressure, the mechanical performance obtained is high: max stress (peak) in bending of 550 to 650 MPa, for modulus values between 27 and 29 GPa.

For the polyamides comprising novolac resin, a slight improvement in performance is observed for the breaking stress.

The form of breaking in tension is markedly more sudden than in the case of the polyamides devoid of novolac resin.

### Example 4

### Characterization of the Composites Based on PA 6.6, after Hygrothermal Aging

The samples prepared according to example 3 were subjected to hygrothermal aging.

A first type of aging was carried out by immersion in water at 65° C. for 65 days (cf. “Amoco” test).

After aging, the test specimens are reconditioned: removal of the adsorbed water by treatment of the test specimens at 90° C. under vacuum for 24 h, followed by stabilization at RH50 by conditioning with a cycle of 10 days at 70° C. under a residual humidity RH of 62%.

The mechanical properties were measured at 23° C. and ambient humidity RH=50% (stabilization of the test specimens at 23° C. for 48 h, RH=50).

The three-point bending tests at ambient temperature are carried out on parallelepipedal test specimens (150×20×2 mm), according to the standard ISO No. 14125, on a Zwick 1478 machine: distance between rods of 64 mm, crosshead velocity of 5 mm/min. The values for Young's elastic modulus E (GPa) and for max stress σ at peak (MPa) are measured and calculated.

TABLE 3
Results for the components manufactured after hygrothermal aging (60°
C.), “Amoco” type, and reconditioning RH50

Three-point bending

| | Elastic modulus E | Max stress σ |
|---|---|---|
| Polyamide used | (GPa) | (MPa) |
| PA C2 | 23 | 350 |
| PA 3 | 25.1 | 450 |
| PA 4 | 25.8 | 495 |

It is thus observed that the mechanical performances are well maintained after hygrothermal aging.

A second type of aging was carried out by immersion in water at 80° C. for 8 days (accelerated test).

After aging, the test specimens were either tested as is or reconditioned by removal of the adsorbed water: treatment at 80° C. under vacuum for 24 h (RH0).

The mechanical properties were measured at 23° C. and ambient humidity RH=50% (test specimens as is or at RH=0).

The three-point bending tests at ambient temperature are carried out on parallelepipedal test specimens (150×20×2 mm), according to the standard ISO No. 14125, on a Zwick 1478 machine: distance between rods of 64 mm, crosshead velocity of 5 mm/min. The values for Young's elastic modulus E (GPa) and for max stress a at peak (MPa) are measured and calculated.

Direct tension tests at ambient temperature are carried out on parallelepipedal test specimens (250×25×2 mm), according to the standard ASTM D3039/D3039M, on a Zwick 1478 machine: crosshead velocity of from 1 to 5 mm/min. The values for Young's elastic modulus E (GPa) and for max stress σ at peak (MPa) are measured and calculated.

TABLE 4
Results for the components manufactured after accelerated hygrothermal
aging (80° C.), state as is and reconditioning RH0

| | |
|---|---|
| Three-point bending | Tension |

| | Elastic | Max | Elastic | Max |
|---|---|---|---|---|
| Polyamide | modulus E | stress σ | modulus E | stress σ |
| used | (GPa) | (MPa) | (GPa) | (MPa) |
| PA C2, as is | 25 | 340 | 26.8 | 290 |
| PA C2 - RH0 | 25 | 450 | 27 | 390 |
| PA 4, as is | 30 | 560 | 27.9 | 460 |
| PA 4- RH0 | 30 | 590 | 28.1 | 487 |

In the case of the unmodified high-melt-flow polyamides, a decline in the mechanical performance, in particular in the max stress (breaking stress), is observed: the maximum stress measured in bending thus changes from 610 MPa (RH50) to 340 MPa (as is) or otherwise from 620 MPa (RH0) to 450 MPa (RH0), i.e. a decline of 45% (wet state) or 30% (RH0).

In the presence of 20% by weight of novolac resin, a marked improvement in the mechanical performance is observed after hygrothermal aging. The aging then brings about a decline of 14% (as is) or 10% (RH0).

A similar behavior is observed in direct tension: decline in the mechanical strength in tension limited to 9% (RH0).

1. A process for the manufacture of a composite article, the process comprising:
a) a stage of impregnation of a reinforcing cloth with a polyamide composition in a molten state, exhibiting a melt viscosity η of between 1 Pa·s and 50 Pa·s, said polyamide composition comprising from 5% to 50% by weight of novolac resin; and
b) a stage of cooling and subsequently of recovering the composite article.

2. The process as claimed in claim 1, wherein the melt viscosity is measured using a plate/plate rheometer with a diameter of 50 mm under a stepwise shear sweep ranging from 1 s⁻¹ to 160 s⁻¹, by melting a film of polyamide with a thickness of 150 μm at a temperature of 25° C. to 30° C. above its melting point.

3. The process as claimed in claim 1, wherein the polyamide is a star polyamide comprising star macromolecular chains and, optionally, linear macromolecular chains.

4. The process as claimed in claim 3, wherein the star polyamide is obtained by mixing in polymerization, in the presence of the polyamide monomers, at least one multifunctional compound comprising at least three identical reactive functional groups which are amine functional groups or carboxylic acid functional groups.

5. The process as claimed in claim 1, wherein the polyamide is selected from the group consisting of polyamides obtained by polycondensation of at least one linear aliphatic dicarboxylic acid with an aliphatic or cyclic diamine or between at least one aromatic dicarboxylic acid and one aliphatic or aromatic diamine, polyamides obtained by polycondensation of at least one amino acid or lactam with itself, blends thereof and (co)polyamides thereof.

6. The process as claimed in claim 5, wherein the polyamide is obtained by addition, before or during the polymerization of the polyamide monomers, of monomers of diamine, dicarboxylic acid, monoamine and/or monocarboxylic acids.

7. The process as claimed in claim 6, wherein the polyamide is obtained by blending, a polyamide with monomers which modify the length of the chains.

8. The process as claimed in claim 1, wherein the reinforcing cloths are fibrous or filamentary networks, the yarns and fibers of which are yarns and/or fibers formed of carbon, glass, aramids, polyimides, flax, hemp, sisal, coir, jute, kenaf and mixtures thereof.

9. The process as claimed in claim 1, wherein the polyamide composition is injected into a molding chamber comprising at least one reinforcing cloth in order to carry out the impregnation.

10. The process as claimed in claim 1, wherein one or more reinforcing cloths and one or more films of polyamide are brought into contact and said impregnation is carried out by melting the polyamide.

11. The process as claimed in claim 1, wherein one or more reinforcing cloths and powder of a polyamide are brought into contact and said impregnation is carried out by melting the polyamide.

12. The process as claimed in claim 1, wherein said process is a pultrusion process.

13. The process as claimed in claim 1, wherein the composite article comprises from 25% to 70% by volume of reinforcing cloth, with respect to the total volume of the article.

14. The process as claimed in claim 1, wherein the novolac resin is a condensation product of phenolic compounds with aldehydes or ketones or their derivatives.

15. The process as claimed in claim 1, wherein the novolac resin exhibits a molecular weight of between 500 g/mol and 3000 g/mol.

16. The process as claimed in claim 1, wherein the composition comprises from 10% to 25% by weight of novolac resin, with respect to the total weight of the composition.

17. A composite article or preform obtained by the process as claimed in claim 1.

18. The process as claimed in claim 7, wherein the blending is melt blending.

19. The process as claimed in claim 7, wherein the monomer is at least one member selected from the group consisting of adiamine, dicarboxylic acid, monoamine and monocarboxylic acid.
